(19) United States
(12) Patent Application Publication
(10) Pub. No.: US 2020/0034571 A1
(43) Pub. Date: Jan. 30, 2020

(54) Method for Smart Contract Data Input through a Proof-of-Work Consensus Mechanism

(71) Applicant: Nicholas Andrew Fett, Frederick, MD (US)

(72) Inventor: Nicholas Andrew Fett, Frederick, MD (US)

(21) Appl. No.: 16/045,662

(22) Filed: Jul. 25, 2018

(51) Int. Cl. G06F 21/64; H04L 9/06; H04L 9/32; G06Q 20/22

(52) U.S. Cl. CPC G06F 21/64; H04L 9/0637; H04L 2209/08; G06Q 20/223; H04L 9/3213

(57) ABSTRACT

System and method for placing cryptographically secure data in a network comprising a public ledger, including associating a transaction inserting data in said network with a cryptographically secure transaction.

The invention is an oracle schema that implements a mineable proof of work (POW) competition to eliminate reliance on trusted third parties for access to off chain data. Users engage in a POW competition to find a nonce which satisfies the requirement of the challenge. The users who find a nonce which correctly solves the POW puzzle input data for the POW Oracle contract and receive native tokens in exchange for their work. The oracle data submissions are stored in the smart contract for use by other on-chain operations

### FIELD OF THE INVENTION

The present invention relates to the method and system for using a proof-of-work consensus mechanism for the determination of a value external to the/a distributed ledger/blockchain network.

### DESCRIPTION OF ILLUSTRATION

It will be readily understood that the instant components, as generally described and illustrated in the figures herein, may be arranged and designed in a wide variety of different configurations. Thus, the following detailed description of the embodiments of at least one of a method, apparatus, and system, as represented in the figure, is not intended to limit the scope of the application as claimed, but is merely representative of selected embodiments.

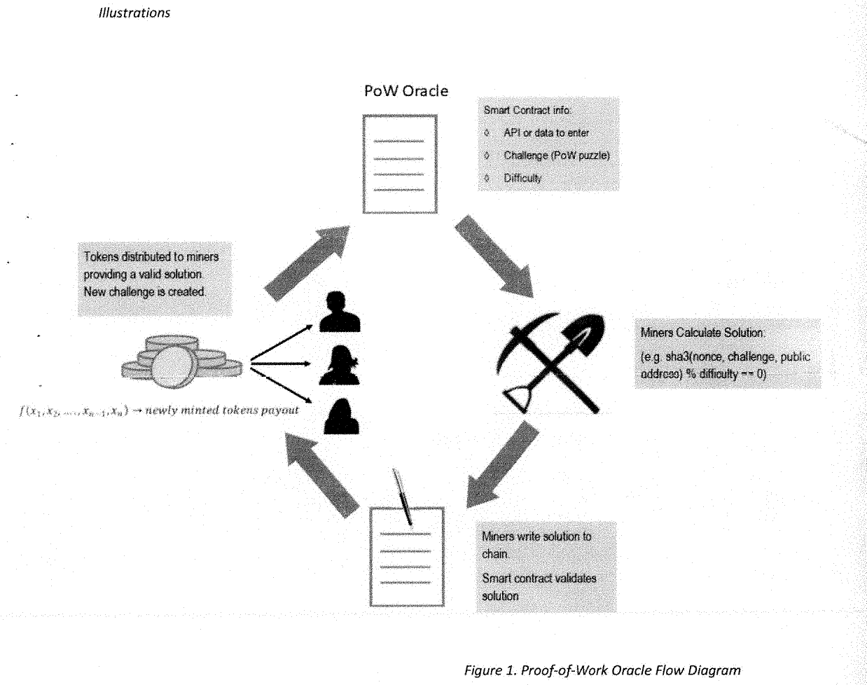

FIG. 1 illustrates the flow for a token issuing oracle contract utilizing proof-of-work for data input and validation.

At the top of the diagram, a contract is created which specifies the data to be input into the contract (e.g. an API address), a difficulty, and a challenge (a random variable to be included in the hash of the solution).

Miners then compete to find a solution to the challenge, an example being the hash of the challenge, nonce (solution), and the public address of the miner will have a certain number of trailing zeros.

When a solution Is found, the miners will then input their solution along with the data requested into the smart contract. Parties will then be paid out an issued token based upon a formula for incentivizing honesty (e.g. median value is selected from n inputting miners).

Once the value is selected, it is stored, and a new challenge is created.

### BACKGROUND OF THE INVENTION

Cryptocurrencies and blockchains began from a paper in 2008 titled Bitcoin: A Peer-to-Peer Electronic Cash System. ¹ This paper outlined the usage of a peer-to-peer network for generating the trust necessary for anonymous electronic transactions. In January 2009, the bitcoin network came into existence. Many other decentralized, distributed consensus networks have come into existence since and are creating new utility and functionality on top of the base layer of a cryptographically secured, distributed and validated database or virtual machine, many of which use a proof-of-work consensus mechanism. ¹ http://bitcoin.org/bitcoin.pdf

In 2018, the ‘mineable token’ was created on the Ethereum network. Parties could then issue new tokens to the winner of a proof-of-work challenge. ² This enabled smart contract networks to layer POW solutions within a given blockchain or distributed ledger system. ² https://github.com/ethereum/EIPs/blob/master/EIPS/eip-918.md

Decentralized computing networks cannot read outside data (e.g. API calls) and rely on third party services to manually enter data into smart contracts. This represents a major point of centralization in an otherwise trustless network. By replacing these third parties with a proof-of-work consensus mechanism, data can be input into the smart contract without necessitating the trust of a third-party data retrieval service.

What is claimed:

1. A computer-implemented method comprising:
a POW definition in this example can apply to blockchain configurations, such ones where a miner is calculating a hash.
input data can be secured/or accepted after n number of miner submissions where n>0
rewards can be in a token native to the smart contract or a staked cryptocurrency where miners are paid from a non-native balance of the smart contract or base oracle contract
The oracle data submissions are stored in contract
data values stored in the contract can be comprised of time-series variables or a non-specific or unique data representation for each mining round (e.g. Boolean values for different events)
reward calculation can be determined using various configurations including mean, median, or mode selections
rewards for neighbor or simply accepted smart contract data submissions can also be implemented for security.
The underlying digital ledger or smart contract computing platform is not specified
As used herein, the term ‘decentralized consensus network (system which POW contract is deployed on) refers to any private or public blockchain or non-blockchain based network that secures the validity of transactions using a non-specific consensus mechanism (e.g. proof-of-work, proof-of-stake, collateral-based voting, or hybrid POS system).
